(19) United States
(12) Patent Application Publication
(10) Pub. No.: US 2022/0354726 A1
(43) Pub. Date: Nov. 10, 2022

(54) SHOULDER REHABILITATION DEVICE AND METHOD

(71) Applicants: Singapore Health Services PTE LTD, Singapore (SG); Singapore University of Technology and Design, Singapore (SG)

(72) Inventors: Siang Hiong Goh, Singapore (SG); Shu Woan Lee, Singapore (SG); Wen Ting Leong, Singapore (SG); Kavya Krishnan Nair, Singapore (SG); Shaun Phua, Singapore (SG); Zhi-en Tan, Singapore (SG); U-Xuan Tan, Singapore (SG)

(21) Appl. No.: 17/621,656

(22) PCT Filed: Jun. 22, 2020
(86) PCT No.: PCT/SG2020/050346

§ 371 Date: Dec. 21, 2021

(30) Foreign Application Priority Data
Jun. 21, 2019 (SG) 10201905763V

(51) Int. Cl. A61H 1/02

(52) U.S. Cl. CPC A61H 1/0281; A61H 2203/0456; A61H 2201/0192; A61H 2201/1207; A61H 2201/1638; A61H 2201/5043; A61H 2201/5061

(57) ABSTRACT

A shoulder rehabilitation device includes an elongated structure and a force generator. The elongated structure is configured to support an arm of a patient, the patient being in a lying position. The force generator is mounted to the elongated structure and configured to apply a traction force on the arm in a distal direction relative to the arm. The elongated structure is rotatable about a pivot adjacent a shoulder joint of said arm. The force generator is further configured to control the traction force to be within a predetermined range.

### TECHNICAL FIELD

The present disclosure relates broadly, but not exclusively, to devices and methods for shoulder rehabilitation.

### BACKGROUND

Anterior shoulder dislocation is a medical condition where the humeral head is displaced anteriorly in relation to the glenoid. Dislocation is typically caused by a blow to an abducted, externally rotated and extended shoulder or a posterior force along the humerus, and commonly occurs in contact sports, vehicular accidents and bad falls. Patients with a previous dislocation, torn rotator cuffs or fractured glenoid have a higher incidence of shoulder dislocation. Shoulder dislocation is the most common dislocation, representing 50% of all major joint dislocations, with anterior shoulder dislocations making up 97% of all shoulder dislocations. This is due to the physiology of the ball and socket joint. To afford mobility, stability is sacrificed, and the socket is extremely shallow, and the humeral head can easily dislocate from the socket.

There are a number of techniques available for reduction of shoulder dislocation, including closed reduction and open reduction, but they carry the risks of fractures (Kocher's technique), injuries to nerves and vessels (Hippocratic method), failure to reduce successfully, and are manpower-intensive as doctors need to be trained to use these techniques. Most of them also require the use of intravenous sedation which carries the risk of low blood pressure, respiratory insufficiency, vomiting and risks of falls and amnesia over the next 24 hours. All of these need much time and manpower for monitoring.

The difficulty of reduction increases with delay in treatment where a delay of more than 24 hours can result in the dislocated shoulder becoming locked in position, due to muscle spasms, and would require an open reduction to resolve. Typically, 1-6 weeks of rest is needed to recover after such treatment. This is followed by physiotherapy to return the shoulder's range of motion back to normal, then strengthening exercises.

Modified Milch and Spaso methods are the most commonly used closed reduction techniques. In the modified Milch method, the patient is made to lie on his or her back. The arm of the dislocated shoulder is then straightened, pointing toward the feet with palm facing upwards. The doctor pulls the arm away from the body by holding unto the distal forearm and the arm is slowly abducted along the coronal plane towards the head while maintaining the distal force. Once the process is complete, the doctor presses just above the armpit to ensure the reduction has occurred.

In the Spaso method, the patient is made to lie on his or her back. The doctor, holding unto the distal forearm or wrist, slowly raises the arm to a vertically straightened position, with the palm facing the body. The doctor then applies further upward force to the arm while rotating the arm such that the palm faces the head, and a counter force may be applied to the armpit by using a foot to press on it. If the shoulder remains un-reduced, the doctor presses the humeral head into the socket

Separately, another medical problem of frozen shoulders (adhesive capsulitis) is a frequent cause of morbidity in the adult and elderly population. It is associated with immobilisation diabetes or injuries, and over time, the shoulder capsule thickens and becomes stiff and tight. Adhesions (due to bands of tissue) occur, causing limitations of motion and stiffness. These can be overcome with rehabilitation and medications in the majority, using continuous passive motion. As it is a time consuming repetitive procedure, but quite easy and safe, a mechanical device can do the work of a physiotherapist, freeing up such a skilled professional for other higher-value activities.

However, it is noted that present continuous passive motion devices for frozen shoulders are clumsy, hard to set up to the differing patient's heights, and have a limited range of motions, Also, they can only be used in a sitting position, whereas most patients and therapists prefer them to be done in a supine position.

It may be desirable to provide a shoulder rehabilitation device that can address at least some of the above problems.

### SUMMARY

An aspect of the present disclosure provides a shoulder rehabilitation device comprising an elongated structure configured to support an arm of a patient, the patient being in a lying position, and a force generator mounted to the elongated structure and configured to apply a traction force on the arm in a distal direction relative to the arm. The elongated structure is rotatable about a pivot adjacent a shoulder joint of said arm. The force generator is further configured to control the traction force to be within a predetermined range.

The elongated structure may be supported by a stand, and a height of the stand is adjustable. The elongated structure may be pivotable relative to the stand between an extended first position in which the elongated structure is substantially perpendicular to the stand and a folded second position in which the elongated structure is substantially parallel to the stand.

The stand may be removably mounted on a base, and the base may comprise a plurality of wheels. At least one of the wheels may be configured to be driven by a motor.

The elongated structure may comprise a proximal end and a distal end opposite the proximal end, and the force generator may be mounted at the distal end of the elongated structure.

The force generator may comprise a wrist cuff configured to securely wrap around a wrist of said arm, at least one strap extending distally from the wrist cuff, and an elastic member connected to the at least one strap and extending toward the distal end of the elongated structure. A length of the at least one strap may be manually adjustable for generating the traction force. The device may further comprise a motor configured to pull a distal end of the at least one elastic member for generating the traction force.

The device may further comprise a force sensor configured to measure the traction force. The device may also comprise a controller coupled to the at least one motor and configured to control the motor. The device may further comprise a display configured to display the traction force.

The device may further comprise at least one visual indicator configured to generate a visual notification if the traction force is outside the predetermined range. Alternatively or in addition, the device may further comprise at least one audio indicator configured to generate an audio notification if the traction force is outside the predetermined range.

The force generator may further comprise an upper arm cuff configured to securely wrap around an upper arm region, the upper arm cuff being connected to the wrist cuff.

Another aspect of the present disclosure provides shoulder rehabilitation method comprising supporting an arm of a patient on an elongated structure while the patient is in a lying position; applying a traction force on the arm in a distal direction relative to the arm, using a force generator mounted to the elongated structure, such that the traction force is within a predetermined range; and rotating the elongated structure about a pivot adjacent a shoulder joint of said arm to abduct said arm.

### BRIEF DESCRIPTION OF THE DRAWINGS

Embodiments of the disclosure will be better understood and readily apparent to one of ordinary skill in the art from the following written description, by way of example only, and in conjunction with the drawings, in which:

FIG. 1(a) shows a shoulder rehabilitation device in an extended position according to an example embodiment.

FIG. 1(b) shows positioning of a patient relative to the shoulder rehabilitation device of FIG. 1(a).

FIG. 1(c) shows the shoulder rehabilitation device of FIG. 1(a) in a folded position.

FIG. 2(a) shows a first perspective view of a shoulder rehabilitation device according to an alternate embodiment.

FIG. 2(b) shows a second perspective view of the shoulder rehabilitation device of FIG. 2(a).

FIG. 2(c) shows a top view of the shoulder rehabilitation device of FIG. 2(a).

FIG. 3 shows a plot of traction force against abduction angle according to an example embodiment.

FIG. 4 shows a force sensing system according to an example embodiment.

FIG. 5 shows a simplified block diagram of a circuit implementing the force sensing system of FIG. 4 according to an example embodiment.

FIG. 6 shows a flow chart illustrating a shoulder rehabilitation method according to an example embodiment.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

The present disclosure provides an assistive mechanical device that performs abduction and traction for shoulder rehabilitation, for example, to reduce an anteriorly dislocated shoulder. Functionally, the device includes three modules: an abduction system, a traction system and a force sensing system. The abduction system includes a standing structure with wheels supporting the full length of a patient's arm at a lying down position. The standing structure has a vertical height is adjustable to ensure alignment with the patient's body, and is able to abduct the hand a full 180-degree motion about the humerus using wheels. In some embodiments, the abduction system is attached to a back plate that allows patients to lie on to anchor the movement of the device, and straps that are designed ambidextrously are used to minimise movement of the patient during reduction. In some embodiments, the traction system uses adjustable straps to allow clinicians to apply a certain traction force by tightening the straps, wrist guards to prevent injury of the wrist on the patient and ensuring minimal movement, and springs to provide allowance of slight distal movements of the hand during abduction and prevent sudden increase in force applied. The application of the traction force that is within a specific range can help to achieve the purpose of relaxing the shoulder muscles throughout the process of abduction to allow the humeral head to enter the glenoid cavity. In some embodiments, the force sensing system uses microcontrollers, sensors and visual and audio feedback in the form of indicator lights and buzzers respectively, to notify clinicians if the traction force applied is within an acceptable range. The device is able to produce consistent and reproducible motion and force to reduce both the involvement of skilled personnel and physical exhaustion.

Embodiments will be described, by way of example only, with reference to the drawings. Like reference numerals and characters in the drawings refer to like elements or equivalents.

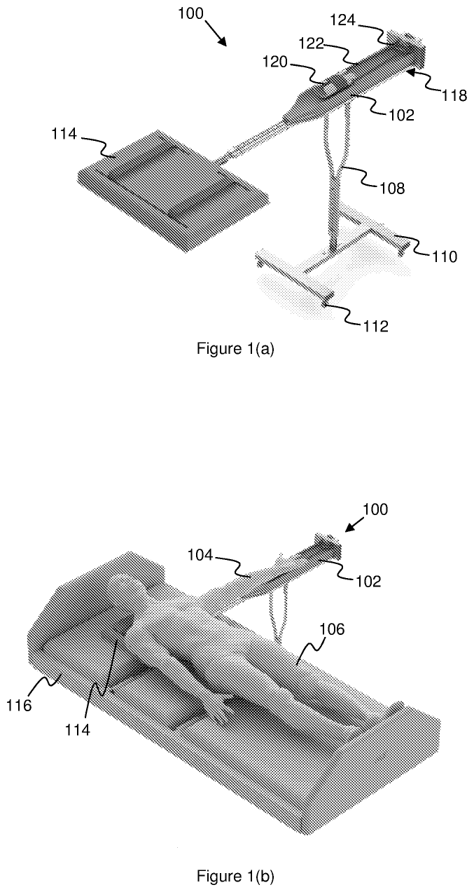

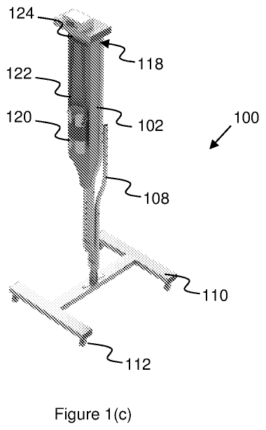

FIG. 1(a) shows a shoulder rehabilitation device 100 in an extended position according to an example embodiment. FIG. 1(b) shows positioning of a patient relative to the shoulder rehabilitation device 100 of FIG. 1(a). FIG. 1(c) shows the shoulder rehabilitation device 100 of FIG. 1(a) in a folded position.

Structurally, the shoulder rehabilitation device 100 includes an elongated structure 102 configured to support an outstretched arm 104 of a patient 106 while the patient 106 is in a lying position (e.g. a supine position as shown in FIG. 1(b)). The elongated structure 102 is supported by a stand 108, which has an adjustable height. The stand 108 is removably mounted on a base 110, which includes a plurality of wheels 112 (e.g. caster wheels). The wheeled base 110 allows the elongated structure 102 to be rotatable about a pivot adjacent a shoulder joint of the arm 104, while supporting the arm 104 at a constant height. For example, the pivot may be located near an edge of a back support 114 in some embodiments. Alternatively, the pivot may be located near an edge of a bed 116 in other embodiments. In a prototype of the shoulder rehabilitation device 100, a force of no more than 1 kgf is sufficient to effect the rotation.

The elongated structure 102 has an adjustable length to accommodate different arm lengths. In addition, the elongated structure 102 is pivotable relative to the stand 108 between an extended first position in which the elongated structure is substantially perpendicular to the stand 108 (as shown in FIG. 1(a)) and a folded second position in which the elongated structure 102 is substantially parallel to the stand 108 (as shown in FIG. 1(b)). For example, a locking mechanism can be used to hold the elongated structure 102 in the extended first position. In the folded position, the elongated structure 102 and the stand 108 can be removed from the base 110 for easy stowage.

The shoulder rehabilitation device 100 also includes a force generator 118 mounted to the elongated structure 102. For example, the elongated structure 102 a proximal end (near to the pivot for rotation) and a distal end opposite the proximal end, and the force generator 118 is mounted at the distal end. The force generator 118 can apply a traction force on the arm 104 in a distal direction relative to the arm 104 and control the traction force to be within a predetermined range, e.g. between 5 and 18 kgf as described in further details below.

As shown in FIGS. 1(a) and 1(c), the force generator 118 includes a wrist cuff 120 that can securely wrap around a wrist the arm 104, at least one strap 122 extending distally from the wrist cuff 120, and an elastic member 124 connected to the at least one strap 122 and extending toward the distal end of the elongated structure 102. The length of the at least one strap 122 can be manually adjustable for generating the traction force. For example, the at least one strap 122 can be shorten to increase the traction force, or lengthened to decrease the traction force. The elastic member 124 can help to dampen the change in the traction force such that any change is not sudden, thereby reducing discomfort to the patient 106.

In some embodiments, the force generator 118 also includes a force sensor to measure the traction force and a display to display the measured traction force. Further, visual and/or audio feedback devices in the form of indicator lights, buzzer, etc. can be incorporated to inform the clinician that the traction force is too low (i.e. not sufficient) or too high (i.e. not safe or comfortable). For example, if a clinically acceptable range of the traction force is 5 to 18 kgf, the feedback devices can be programmed to be triggered if the measured traction force is outside this range.

In an example deployment of the shoulder rehabilitation device 100, the back support 114 is first placed on the bed 116. The elongated structure 102 and stand 108 are mounted on the base 110 and the height of the stand 108 is adjusted such that the elongated structure 102 is aligned with the level of the back support 114. The back support is then connected to the elongated structure 102 at the pivot hinge and its lateral position on the bed 116 is adjusted based on the length of the patient's height. The patient 106 can then lie on the back support 114 and be strapped in, and the procedure comprising traction and abduction is performed. The disassembly procedure is in the reverse order. The back support 114 is first removed from the elongated structure 102. The elongated structure 102 is then folded into the stand 108 and both are removed from the base 110. The components can then be kept in a compact manner for a subsequent use.

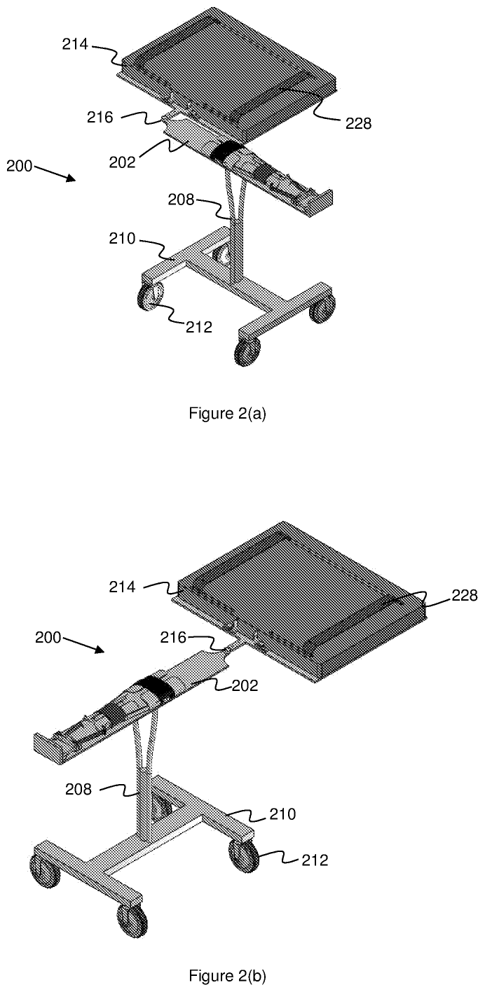

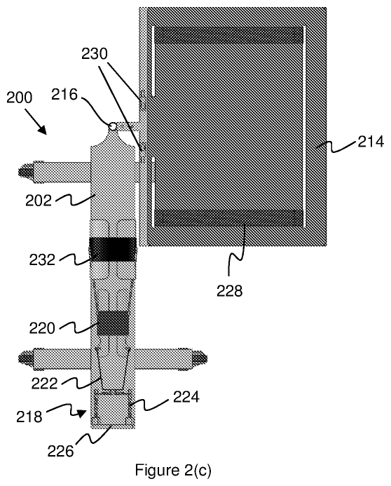

FIG. 2(a) shows a first perspective view of a shoulder rehabilitation device 200 according to an alternate embodiment. FIG. 2(b) shows a second perspective view of the shoulder rehabilitation device 200 of FIG. 2(a). FIG. 2(c) shows a top view of the shoulder rehabilitation device 200 of FIG. 2(a).

The shoulder rehabilitation device 200 is mostly similar to the shoulder rehabilitation device 100, and includes an elongated structure 202 supported by a stand 208 which has an adjustable height. The stand 208 is removably mounted on a base 210, which includes a plurality of wheels 212. At least one of the wheels 212 is powered by a motor (i.e. motorized) to enable the necessary rotation to provide the abduction of the hand about the humerus, without requiring an operator to push the base 210. The speed of the rotation may be controllable to ensure a gradual abduction and to minimise discomfort to the patient. As shown in FIGS. 2(a) and 2(b), the motorized wheels 212 can drive the base 210, stand 208 and elongated structure 202 to about a pivot 216 to effect abduction.

The shoulder rehabilitation device 200 also includes a force generator 218 mounted at a distal end of the elongated structure 202. The force generator 218 can apply a traction force on the patient's arm in a distal direction relative to the arm and control the traction force to be within a predetermined range. The force generator 218 includes a wrist cuff 220 that can securely wrap around a wrist of the arm, at least one strap 222 extending distally from the wrist cuff 220, and an elastic member 224 connected to the at least one strap 222 and extending toward the distal end of the elongated structure 202. In this embodiment, a motor 226 with a force sensing system is used to pull the elastic member 224 to provide the appropriate traction force. The force sensing system includes a force sensor to measure the traction force and a controller coupled to the motor 226 to ensure that the applied traction force is within the acceptable range. Similar to the embodiment in FIGS. 1(a)-1(c), the force generator 218 also can provide a display of the traction force, and visual and/or audio feedback to notify the clinician if the applied traction force is not within the acceptable range.

In use, the patient may be requested to lie on a back support 214 in a supine position and a strap 228 may be used to secure the patient's body from lateral movement. The back support 214 may be placed on a bed or a bench. The patient's arm with the dislocated shoulder is placed on the elongated structure 202 a height level with the patient's body. Two rods 230, which may be located at a side of the back support 214, may be used as fixation device to prevent the shoulder joint of the patient from displacing. The wrist cuff 220 is strapped around the wrist. In addition, an upper arm cuff 232, which is connected to the wrist cuff 220, is used to securely wrap around the upper arm area to provide distributed force during the rotation of the elongated structure 202. This can help to avoid issues like arm fracture if the force is concentrated at the wrist region. The motor 226 pulling the elastic member 224 is activated to provide the necessary traction force, and the motor driving at least one of the wheels 212 is activated provide needed rotation of the shoulder while maintaining the distal force. In some embodiments, an encoder is disposed at pivot 216 to monitor the rotation.

By making use of motorized components, the shoulder rehabilitation device 200 can reduce the physical exertion of the clinician while providing relaxation of the shoulder muscles throughout the abduction to enable the humeral head to enter the glenoid cavity smoothly. The required manpower, as well as supervision, can be reduced such that one-person operation is possible, and standardisation of reduction and rehabilitation procedures can be achieved. The shoulder rehabilitation device 200 is also safe and gentle with minimal monitoring, and does not require the use of anesthesia. An over-ride/abort safety feature may be incorporated to allow the clinician to intervene if necessary.

The shoulder rehabilitation device as described with reference to FIGS. 1(a)-1(c) and FIGS. 2(a)-2(b) can also be considered as having three separate sub-systems each with its own functions, namely, the abduction system, the traction system, and the force sensing system.

The abduction system (comprising the elongated structure, stand and base) guides the arm in the desired motion which is abduction in the coronal plane from the caudal direction to the cranial direction. The traction system (part of the force generator) provides the traction force required to relax the shoulder muscles to allow the humeral head to be moved back into the glenoid cavity of the shoulder blade. The force sensing system (part of the force generator) is used to indicate to the clinician the exact force that is applied on the patient while ensuring that the clinician applies a force that is within the safe and acceptable zone, e.g. between 5 and 18 kgf.

As mentioned, the abduction system provides a mechanism to guide the abduction process on the patient's dislocated shoulder or frozen shoulder, essential in the modified Milch method of closed reduction. The patient may be requested to lie on the back support and the arm of the patient will follow an arc guided by the pivot. By placing the patient's shoulder joint over the pivot, the 180° rotation by the elongated structure would result in a 180° abduction motion of the patient's arm, constraining the abduction motion to follow an arc centred about the patient's shoulder joint. The stand provides variable height to allow the device to be on the same level as the bed, keeping the patient's arm along the coronal plane. Hence, the device is able to satisfy the requirements of abduction for the modified Milch method, that is 180° abduction about the shoulder joint along the coronal plane. In embodiments, either a small force of no more than 1 kgf or actuation of a motor can be applied to provide the abduction motion.

The traction system provides a distal force to the shoulder to relax the shoulder muscles through a manual tightening of the adjustable strap or a motorized pulling of the elastic member (e.g. a spring). The spring can provide elasticity to the otherwise inelastic system, such that the spring stiffness allows a gradual increase of traction force applied on the hand. In addition, the lower stiffness can reduce the impact of patient shifting and positioning inaccuracy on the traction force. For example, the spring may be selected to be able to tolerate the traction force of 5-18 kgf. The wrist cuff provides comfort by spreading out the traction force over the patient's wrist and a point of anchor for the traction system to generate the pulling force on the arm.

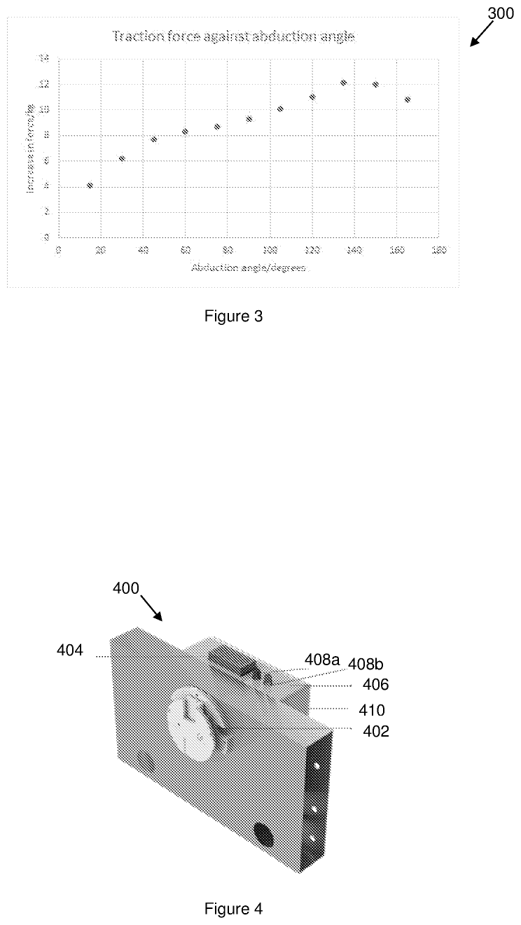

FIG. 3 shows a plot 300 of traction force against abduction angle according to an example embodiment. In this example, the traction force increases by about 8 kg (from 4 kg to 12 kg) and reaches a maximum at about 135°. From clinical data, it is possible to determine an optimal profile of the traction force relative to abduction angle, such that in an embodiment where motorized traction and abduction is applied, the torque and speed of the motors can be programmed to follow the optimal profile. Further, the torque and speed of the motors can be programmed to suit an attribute of the patient, e.g. age, sex, body size, etc. For example, a smaller traction force may be applied to a patient having a lower body weight or a smaller size, and the speed can be slowed down if the patient is anxious or in a lot of discomfort from the injury.

The traction force sensing system can notify the clinician whether the applied traction force is within the safe limit, e.g. 5-18 kgf. FIG. 4 shows a force sensing system 400 according to an example embodiment. The force sensing system includes a force/load sensor 402 that can detect the applied traction force and display it on a display device 404, e.g. a 7-segment display screen. As shown in FIG. 4, the force sensing system 400 also includes a casing 406 enclosing electronic components, visual indicators in the form of light emitting diodes (LEDs) 408a, 408b, an audio indicator in the form of a buzzer (not shown), and a switch 410. While not shown in FIG. 4, a motor for generating the traction force and its associated electronics may also be incorporated with the force sensing system 400. In one example implementation, when the traction force is below e.g. 5 kgf, the red LED 408a lights up, while the buzzer remains off (i.e. inactivated), indicating that the traction force is too low. When the traction force is within the acceptable range of 5-18 kgf, the green LED 408b lights up, indicating a safe zone. However, when the traction force exceeds the maximum limit of e.g. 18 kgf, the red LED 108a lights up and the buzzer goes off (i.e. activated), to alert the clinician to stay within the safe zone. In other words, the audio and visual notification system allows the clinician to adjust the traction force accordingly.

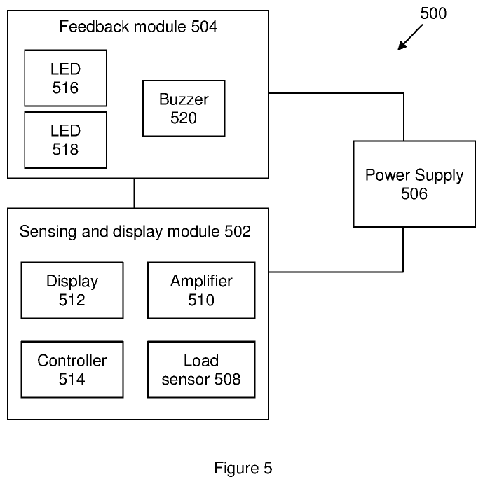

FIG. 5 shows a simplified block diagram of a circuit 500 implementing the force sensing system 400 of FIG. 4 according to an example embodiment. For brevity, peripheral or interface devices have been omitted in FIG. 5. The circuit 500 includes a sensing and display module 502, a feedback module 504 and a power supply 506. The sensing and display module 502 includes a force/load sensor 508 (e.g. a 50-kg load cell), an amplifier 510 (e.g. HX711 load cell amplifier), a display 512 (e.g. TM1637 7-segment display), and a controller 514 (e.g. Arduino Nano). The feedback module 504 includes visual indicators in the form of red LED 516 and green LED 518, and an audio indicator in the form of buzzer 520. It will be appreciated that other different circuit components may be selected in alternate embodiments. For example, in some embodiments, a motor may be incorporated into the circuit 500 and the operation of the motor may be controlled based on the output of the force/load sensor 508.

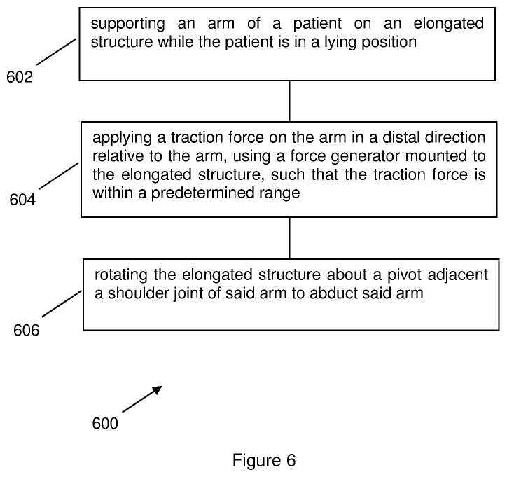

FIG. 6 shows a flow chart illustrating a shoulder rehabilitation method according to an example embodiment. At step 602, an arm of a patient is supported on an elongated structure while the patient is in a lying position. At step 604, a traction force is applied on the arm in a distal direction relative to the arm, using a force generator mounted to the elongated structure, such that the traction force is within a predetermined range. At step 606, the elongated structure is rotated about a pivot adjacent a shoulder joint of said arm to abduct said arm.

It will be appreciated by a person skilled in the art that numerous variations and/or modifications may be made to the present disclosure as shown in the specific embodiments without departing from the scope of the disclosure as broadly described. For example, for rehabilitation of frozen shoulders, the device may be adapted to provide additional degrees of freedom, including incorporating additional motors, while still providing a traction force. The present embodiments are, therefore, to be considered in all respects to be illustrative and not restrictive.

1. A shoulder rehabilitation device comprising:
an elongated structure configured to support an arm of a patient, the patient being in a lying position; and
a force generator mounted to the elongated structure and configured to apply a traction force on the arm in a distal direction relative to the arm,
wherein the elongated structure is rotatable about a pivot adjacent a shoulder joint of said arm; and
wherein the force generator is further configured to control the traction force to be within a predetermined range.

2. The device according to claim 1, wherein the elongated structure is supported by a stand, and wherein a height of the stand is adjustable.

3. The device according to claim 2, wherein the elongated structure is pivotable relative to the stand between an extended first position in which the elongated structure is substantially perpendicular to the stand and a folded second position in which the elongated structure is substantially parallel to the stand.

4. The device according to claim 2, wherein the stand is removably mounted on a base, and wherein the base comprises a plurality of wheels.

5. The device according to claim 4, wherein at least one of the wheels is configured to be driven by a motor.

6. The device according to claim 1, wherein the elongated structure comprises a proximal end and a distal end opposite the proximal end, and wherein the force generator is mounted at the distal end of the elongated structure.

7. The device according to claim 6, wherein the force generator comprises:
a wrist cuff configured to securely wrap around a wrist of said arm;
at least one strap extending distally from the wrist cuff; and
an elastic member connected to the at least one strap and extending toward the distal end of the elongated structure.

8. The device according to claim 7, wherein a length of the at least one strap is manually adjustable for generating the traction force.

9. The device according to claim 7, further comprising a motor configured to pull a distal end of the at least one elastic member for generating the traction force.

10. The device according to claim 8, further comprising a force sensor configured to measure the traction force.

11. The device according to claim 9, further comprising a controller coupled to the at least one motor and configured to control the motor.

12. The device according to claim 10, further comprising a display configured to display the traction force.

13. The device according to claim 10, further comprising at least one visual indicator configured to generate a visual notification if the traction force is outside the predetermined range.

14. The device according to claim 10, further comprising at least one audio indicator configured to generate an audio notification if the traction force is outside the predetermined range.

15. The device according to claim 7, wherein the force generator further comprises an upper arm cuff configured to securely wrap around an upper arm region, the upper arm cuff being connected to the wrist cuff.

16. A shoulder rehabilitation method comprising:
supporting an arm of a patient on an elongated structure while the patient is in a lying position; and
applying a traction force on the arm in a distal direction relative to the arm, using a force generator mounted to the elongated structure, such that the traction force is within a predetermined range; and
rotating the elongated structure about a pivot adjacent a shoulder joint of said arm to abduct said arm.
